(19) United States
(12) Patent Application Publication
(10) Pub. No.: US 2024/0045988 A1
(43) Pub. Date: Feb. 8, 2024

(54) ENHANCED USER SECURITY THROUGH A MIDDLE TIER ACCESS APPLICATION

(71) Applicant: SKYFLOW INC, Los Altos, CA (US)

(72) Inventor: Daniel ManHung Wong, Palo Alto, CA (US)

(21) Appl. No.: 17/881,468

(22) Filed: Aug. 4, 2022

(51) Int. Cl. G06F 21/62; G06F 21/33

(52) U.S. Cl. CPC G06F 21/6245; G06F 21/33

(57) ABSTRACT

User security through a middle tier access application is enhanced using a token. In a method, a user authentication request to access a database is received from an end client. The user is authenticated. An identity assertion token is obtained after authenticating the user. The identity assertion token includes a personal identifier. A database request is received from the end client and the database request is sent to the database with the identity assertion token. A reply is received from the database in response to the database request if the personal identifier corresponds to a record stored at the database. The reply received from the database is sent to the end client.

### FIELD

Embodiments of the invention relate to the field of data security, and more specifically, to enhancing user security with a middle tier access application.

### BACKGROUND

In recent decades, businesses have significantly increased the amount of sensitive data they collect in order to create personalized customer experiences and unlock new growth opportunities. At the same time, secure data storage has become more difficult as private and state actors relentlessly strive to obtain unauthorized access to private data. Recently, the personal, medical, and financial records of many private data repositories have been exposed to the public. Other records have been stolen and sold to third parties. In response to the frequent exposure of private information, some governments have implemented new laws requiring that certain kinds of data, such as personal and health information be kept secure. At the same time, business success may also require that trade secrets and business relationships be kept secure.

A secured database can be configured as a data vault with restricted access. Each end client is authenticated to the specific permissions that have been granted by a security administrator. An access application can be used as a middle tier between the end client and the database. The access application can provide for authentication, authorization, permissions control, and security between the end client and the database. The access application may be operated as an application or a web interface on the hardware of the end client, on a server through an intranet, or at a cloud-accessible utility. The access application communicates with the secured database to read or write data or perform other operations. The user interacts with the access application through the end client and the access application interacts with the secured database.

### BRIEF DESCRIPTION OF THE DRAWING FIGURES

The invention may best be understood by referring to the following description and accompanying drawings that are used to illustrate embodiments of the invention. In the drawings:

FIG. 1 is a block diagram of a high-speed infrastructure with high availability and security according to embodiments of the invention;

FIG. 2 is a block diagram of a system with multiple account access to data vaults according to embodiments of the invention;

FIG. 3 is a block diagram of a secure vault in a data plane with control plane access according to embodiments of the invention;

FIG. 4 is a diagram of a configuration of access to a data vault according to embodiments of the invention;

FIG. 5 is a block diagram of components in a process that provides a user with access to a secured database through an end client and an access application according to embodiments of the invention;

FIG. 6 is a process flow diagram of a method of user security with a middle tier access application according to embodiments of the invention;

FIG. 7 is a process flow diagram of a method of user security with a database and an access application according to embodiments of the invention;

FIG. 8 is a signaling diagram of accessing a database using an identity assertion token according to embodiments of the invention; and

FIG. 9 is a block diagram of a computer system 900 representing an example of a system upon which features of the described embodiments may be implemented.

### DETAILED DESCRIPTION

When an end client logs in to an access application, the end client provides credentials that are authenticated at the access application. The access application uses its own credentials to authenticate the access application to the secured database. The access application also implements its own application flow and policies through its own authentication and authorization of the user. The access application may use a separate authentication utility or authentication service to authenticate the end client to the access application. After a successful user authentication, the access application can request a user identifier from the authentication utility. The user identifier can present the user's identity. By presenting such a user identifier, the access application can validate the user at each query or at each session for which operations are conducted by the access application on behalf of the end client.

As described herein, to support strong and fine-grained data access in a multi-tier architecture, end client authentication and authorization is incorporated as part of the security enforcement at the secured database. In order to control and limit data access, the secured database accepts or validates an identity assertion token using a validation of the user's identity. Optionally, a user account database is matched through a configurable scheme to the corresponding data ownership of the secured database.

The user identifier may take many different forms. In examples described herein, a first type of user identifier is an identity assertion token issued by the authentication utility after successful user authentication. The authentication utility can optionally be separate and apart from the hardware being used by the user to access the access application. The identity assertion token may contain user name, telephone number, email address, or other personal identifiers may be used. The identity assertion token may contain an expiration time to reduce the chance that the identify assertion token is re-used by another. The identity assertion token may contain a digital signature to ensure that the authentication utility that issued the token is a valid trusted party. The digital signature may be validated by the access application and by the secured database before acting on the token.

A second type of user identifier is for the database (called a dB ID herein). Such an identifier provides a link to the user's authorizations, permissions, and history with the database. Unlike the identity assertion token, which may have a digital signature technology, this second type of user identifier is not required for assertion. The access application can generate a variety of different user identifiers and there may be class and status identifiers associated with or incorporated into various types of user identifiers.

As described herein, the access application provides the identity assertion token to the secured database. The secured database checks any received user identifiers against its own records before providing access to the access application. Using the identity assertion token, only the presence of the authenticated and authorized user is able to perform transactions. In embodiments, the identity assertion token is generated only with the end user's presence. This guarantees that the end user is indeed present and active in the session. An attacker that takes over the access application does not have the identity assertion token and will therefore be blocked by the secured database.

In embodiments, the access application uses a separate utility or service for user authentication. The separate authentication utility or authentication service has information about the user sufficient to authenticate the user and, using this information, is able to generate an identity assertion token for each authentication. The identity assertion token carries an identifier of the user that is provided to the access application. The access application may forward the identity assertion token with queries or session requests to authenticate the user to the secured database. The identity assertion token may be used to validate the user's identity. In some implementations, a dB ID is also used in addition to the identity assertion token to confirm permissions and ownership rights at the secured database.

In some embodiments the identity assertion token has the format of a JavaScript Object Notation (JSON) Web Token (JWT). A JWT is a JSON object with a header, payload, and signature used to securely transfer information over network connections between the two parties. It is used for authentication and can also be used for information exchange.

For purposes of the present description, the following terms may be understood in light of the definitions below. Variations, modifications, and additions may be made to the definitions to suit a particular implementation.

User: a person that seeks access to a secured database.

End client: an electronic terminal with a user interface and communication capabilities.

Authentication utility: a utility capable of authenticating the identity of a user through an end client for purposes of using a utility or service, for example a secured database. The utility may operate on the end client, in the access application, or as a remote service accessible through a local network or Internet.

User credentials: a user name and password created by a user to authenticate the user to the authentication utility. The password may be in the form of a character sequence, personal identifier, biometrics, a multi-factor authentication information, etc.

Personal identifier: code or number based on information independent of the secured database and independent of the end client that uniquely identifies a user, for example a name, a code, a telephone number, an email address, a date of birth, a social security number, a residential or work address, etc. The personal identifier may be hashed, truncated, inverted, or otherwise modified.

Access application credentials: credentials used by an access application to authenticate the access application to the secured database and may include an application ID and any suitable secrets, for example a password, a digital signature, or security encryption keys.

Identity assertion token: a web token with a header, a payload and an authentication utility digital signature. The header contains issuer information, expiration, type of encryptions used, etc. The payload contains at least one personal identifier or another user identifier.

Authentication utility digital signature: a number or code generated by the authentication utility and included in or with the identity assertion token to identify and verify the identity of the authentication utility to the access application and the secured database.

User identifier: any code, number, or token that uniquely identifies a particular user, for example the identity assertion token or the dB ID.

Database request: a request sent from the end client to the secured database through the access application for a query, a report, or administration.

Database validation of the user: a process to ensure that an authorized user is sending a request, which may include authenticating a digital signature of an authentication utility and comparing a personal identifier in a user assertion token to a stored personal identifier.

dB ID (database identification): a number or code that is unique to a user with a link at the secured database to the security policy, database history for the user, or other useful information of the user.

Security policy: authorizations, roles, permissions, etc. for using the secured database.

User presence: active participation of a user in the computation environment.

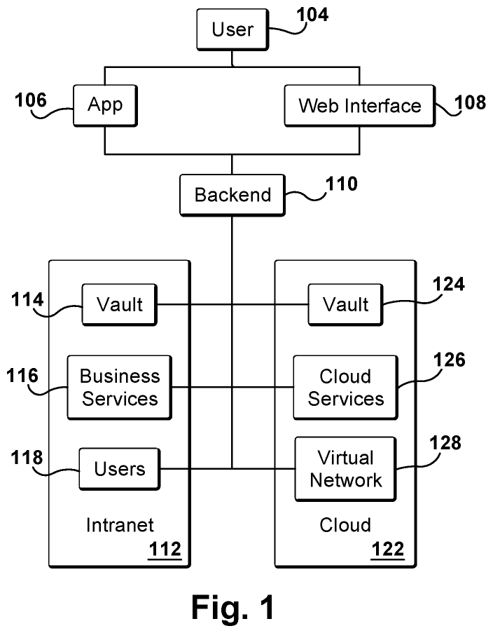

FIG. 1 is a block diagram of a high-speed infrastructure with high availability and security in combination. In this infrastructure a user 104 has access to resources through an app 106, through a web interface 108 or through any other suitable interface. The app and web interface present an access application to authenticate the user 104. The user may be a member, vendor, customer, or employee of an enterprise. Other users obtain access to enterprise resources in the same or a similar way. All of the interfaces connect through a backend 110. Privacy-first APIs may be configured to be highly available and backed by a highly secure backend hosted on a cloud service or a local network. The user 104 may be isolated by the backend for different services across customer instances to ensure unparalleled security and privacy. On one side, the backend is coupled to, and may be hosted by, an intranet 112 to support internal business processes of the enterprise. On another side, the backend is coupled to, and may be hosted by, a cloud-hosting side 122 including cloud services 126 for wide availability.

The intranet 112 includes a discrete secure vault 114, also referred to herein as a secured database, that is isolated from other resources. The intranet also includes any business services 116 used to support the work of the enterprise and connections to other users 118 that may also be working with the business services 116. The cloud hosting 122 may be used to host a vault 124 or secured database, cloud services 126 used by the enterprise, and a virtual network 128 that provides connections to other resources and users of the enterprise. The vault 114 on the local side 112 and the vault 124 on the cloud-hosted side 122 may be hosted in different regions and availability zones to ensure availability and to transparently handle and recover from failures without service disruption. Synchronous data replication may be employed to minimize data loss in the event of local failures. In embodiments, users 104 are allowed access to all of the services 116, 118, 126, 128 through apps 106 and other interfaces 108 but are only allowed access to the vault 114, 124 when needed and only through dynamic, fine-grained policies.

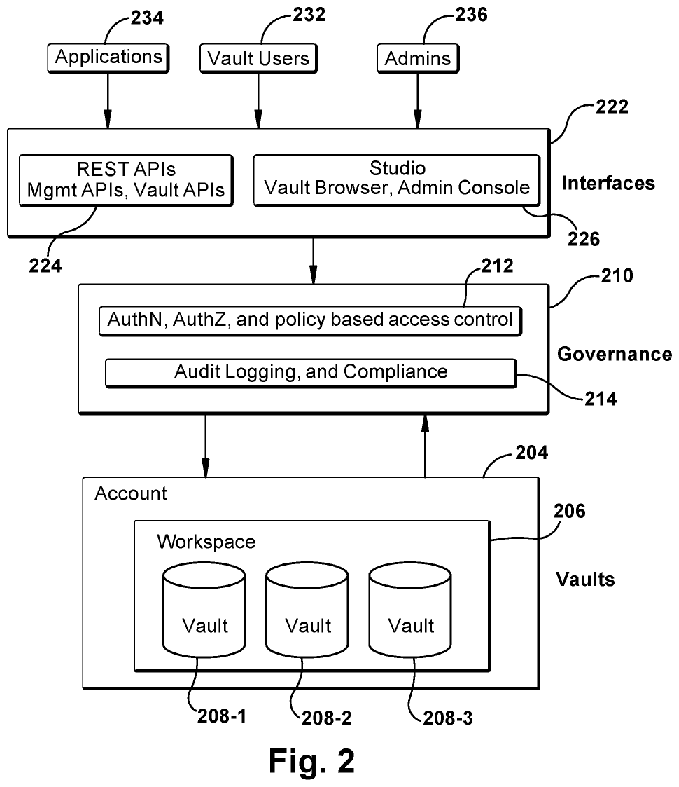

FIG. 2 is a block diagram of a system with multiple account access to data vaults. An account 204 includes a workspace 206 that includes one or more data vaults 208-1, 208-2, 208-3. The data vaults, or secured databases, are secure and use sophisticated privacy technology to keep data secure and private. The vaults 208 may be isolated, highly distributed, and highly available to store sensitive data. The data may be encrypted at rest, in transit, and in-memory while being processed. This constant encryption dramatically improves the business security posture, as a significant number of data breaches happen on in-memory data. On top of strong encryption, the vaults 208 may incorporate several privacy-preserving technologies to protect sensitive data.

The data in a vault may be configured in any of a variety of different ways. In embodiments, a high-level schema is provided as a working template based on typical business needs. The template may include fields and relations in a database format. For example, a customer identity vault template may include the sensitive fields a business would typically want to collect about a customer (e.g., name, email, address, telephone number, billing account, organization, date of birth, etc.). An administrator may add or delete fields and populate the template with actual data.

In some embodiments enterprise-grade governance tools 210 control access to the account and the vaults. The governance tools may include any of a variety of different policy-based access controls 212 and audit, logging, and compliance controls 214 to grant or deny access to data in the vaults 208. Data sets in a data vault may have corresponding audit logs that record all events. The logs may be aggregated and reported in analysis, audit, and metrics dashboards. The governance tools may also provide a Role-Based Access Control (RBAC) model in addition to a Policy-Based Access Control model. RBAC provides easy access control to stakeholders based on roles and privileges.

Users 232, applications 234, and administrators 236 obtain access to the governance tools through a direct interface 222, such as a browser interface and administrative console, or through APIs (Application Programming Interfaces) 224, such as REST (Representational State Transfer) APIs, management APIs, and vault APIs. The browser interface may be used to enable data exploration and account management with a simple graphical user interface. Clicking on various links, panes, windows, and dialog boxes may be configured to drive queries and other operations. The APIs allow applications and user interfaces to obtain access to the data vaults for a variety of user functions. The APIs may also be used for account and workspace management functions. Middle tier applications, such as access applications may be integrated into or accessed by the interfaces 222.

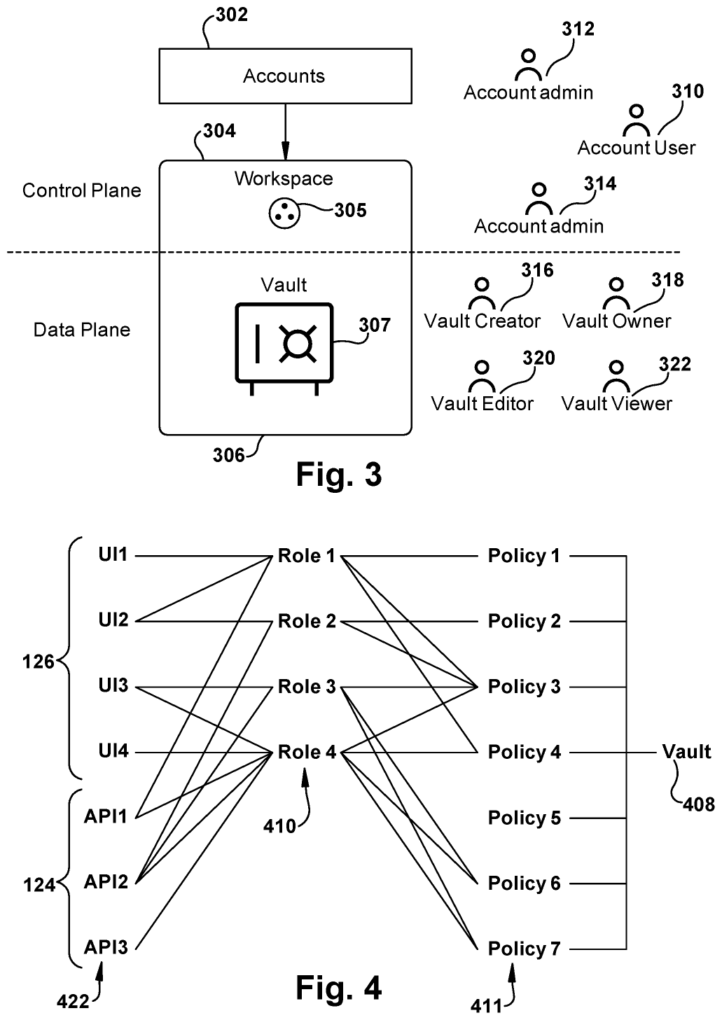

FIG. 3 is a block diagram of a secure vault or secured database in a data plane with control plane access to indicate some of the roles that may be supported. The accounts 302, as shown in FIG. 2, gain access to the vault 307 through a workspace 305. The accounts and the workspace may be considered to be in a control plane 304 and the vault may be considered to be in a data plane 306. Within the control plane are a class of workspace users 310 that have roles that require access to the workspace and limited access to the encrypted data in the vault based on roles and allowed policies. For the roles of these workspace users 310, the vault data is encrypted.

The roles may include administrative roles. A role for an account administrator 312 may include ability to add new accounts for new interfaces and add new roles for those interfaces. A role for a workspace administrator 314 may include controlling access to the workspace including one or more data vaults and managing the workspace and the data stored in the data vaults. A workspace administrator role may include policies for viewing and editing the secure data in plain text or any other suitable native or human-readable format.

Vault roles have access to the data in the data plane 306 that resides in the data vault 307. A vault creator 316 may have an ability to create the schema for the data in the vault and to populate the data in the vault. A vault owner 318 may serve as a custodian of the data in the vault and may control access to the data in the vault. This may include creating roles or policies that allow for access to the vault data. A vault editor 320 may have access to view and edit the data in the vault but may be prohibited from viewing the data in plain text as the vault owner can. A vault viewer 322 may have access to view the data in the vault with certain limitations but not to edit or modify or delete any data. The various roles shown in FIG. 3 are provided as examples and the capabilities, names, and other characteristics of any one or more of these roles may be modified to suit any particular circumstance. Each of the roles may be linked to a database identification (dB ID). The dB ID may connect to a table in the database that links to a user's security policy and history.

FIG. 4 is a diagram of a configuration of access to a data vault 408. Interfaces 422 which may include user interfaces 226 and APIs 224 are each coupled to a governance layer through associations with one or more roles 410. The roles are each associated with one or more policies 411 and with one or more interfaces. The policies allow access to the data vault 408. The governance layer provides a set of capabilities that enable customers to govern and control access to sensitive data that reside in the data vault. The governance layer enforces granular, real-time decisions on every data access request with minimum latency. The user interfaces 226, using a browser or console, allow a policy expression language and an accompanying policy code editor to be used to author complex and condition-based access rules as policies 411. Each role corresponds to a grouping of policies that allow a user or group of users to act in that role, such as account representative, physician, billing, scheduling, customer support etc. Stated another way, policies are reusable sets of access rules that can be attached to one or more roles. The policies allow a dynamic, granular, real-time, condition-based set of rules to govern access to the vault. The policies associated with the role allow the user in that role to perform only those operations that are needed for the role.

The plurality of roles allows an approach of isolate, protect, and harness to manage sensitive data access. Applications are allowed to communicate with each other and to share data through the APIs 224. This harnesses the value of the sensitive data. However, each API is associated with only selected roles. The policies may be configured to employ data loss prevention techniques such as tokenization, redaction, masking, and encrypted computing so that the same data is shared differently depending on the assigned role. In an example, a vault owner creates a policy, then authors a set of granular rules for it. The vault owner can then attach this policy to one or more roles. This action grants a set of permissions to the role. The role can then be assigned to users (UI) or Service Accounts (API).

In one example, a credit card applicant sees her own PII (Personally Identifiable Information) including her SSN (Social Security Number) in plain text. However, a customer support agent sees only the last 4 digits of her SSN for identity verification purposes. The rest is masked. In another example, a front-office staffer leverages the power of encrypted computation to match the SSN of a customer without ever viewing the entire SSN column in plain text. Only a confirmation of the match is displayed. In the United States, the SSN is a unique nine-digit number assigned to a person for taxpayer identification purposes. It is also used for banking, medical, and insurance transactions. In another example, a physician can view and edit medication information of only those patients she treats and not the entire patient database. In another example, medical test and treatment results for a patient are shared with government officials only if the patient has given consent to share their data.

The policies and the structure of the data vault may be used to minimize data access with granular access control. The attack surface area of sensitive data is reduced. The roles may be used to ensure that user interfaces and apps have access only to the specific fields needed to perform the permitted operations that support a legitimate business function. In the example of a data table model, very granular and condition-based access policies may be provided by using column-level and row-level access control, support for SQL WHERE clauses, and Common Expression Language.

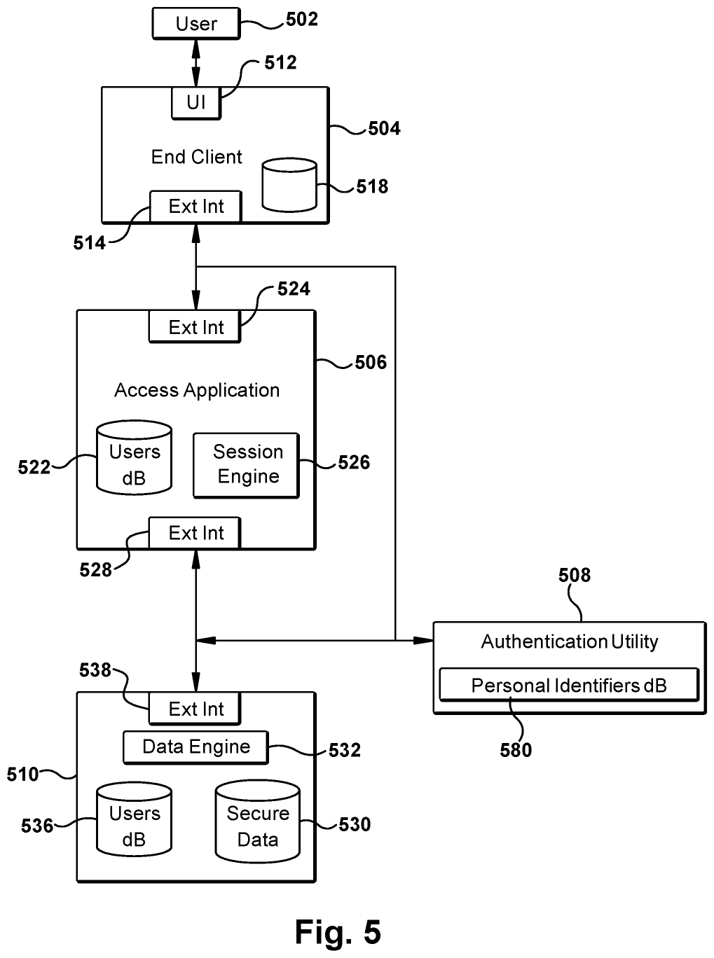

FIG. 5 is a block diagram of components in a process that provides a user with access to a secured database through an end client and an access application. A user 502 interacts with an end client 504 through a user interface 512 to obtain access to a database 510 through an access application 506. The end client 504 may be any suitable communications terminal, for example a desktop, workstation, or notebook computer, a dumb client, thin client, tablet, cellular telephone, or other mobile device. The end client 504 has a user interface 512 to receive or send data and commands and an external interface 514 to communicate with other components of the system. The end client has processing resources and a memory (not shown) that connect the user interface and the external interface and allow for data and commands to be adapted to suitable protocols and modulation systems of the user interface 512 and the external interface 514. The end client has a data store 518 for remote addresses, passwords, identifiers and tokens. The user 502 gains access to the end client 504 in any of a variety of suitable ways such as user name and password, biometrics, etc.

The access application 506 has an end client interface 524 (external interface) for communication with the end client 504 as described above. The access application has an external interface 528 that is connected to the authentication utility 508. The external interface 528 may be the same as or different from the end client interface 524, depending on the network architecture. The authentication utility may operate as a remote service that has a personal identifiers database 580 and other resources to authenticate the user. The personal identifiers database 580 contains one or more codes or numbers associated with each respective user and that are independent of the end client. The personal identifiers database 580 may also be used by the access application to retrieve a personal identifier for the authenticated user from the database 580 and then insert the personal identifier into the identity assertion token. The access application directs the end client to the authentication utility for authentication. This may be done directly between the end client and the authentication utility or through the access application. After authentication, the access application receives an authentication from the authentication utility and an identity assertion token for the user. The authentication allows the access application to provide access to the database 510 using the token.

The access application may be configured as a web application in which the end client uses a web browser or a specialized application on the end client and an address to connect to the access application. The end client is connected to the access application through an intranet, a VPN (virtual private network), or the Internet. The access application 506 has a session engine 526 to manage any secure sessions with the authentication utility 508 and the database 508. The access application session engine may also manage secure sessions with the end client. The access application may alternatively be configured as a standalone application on the end client in which case all of the components of the access application are integrated into the end client. The access application may operate on a server, router, or another suitable device or on the end client in which case the network interface 514 may be a software interface or a bus interface.

The user 502 authenticates to the authentication utility with user credentials by sending the user credentials from the end client 504 to the authentication utility 508 directly or through the access application 506. The end client may communicate with the authentication utility directly or the access application may establish a secure session with the authentication utility using the session engine 526 for this purpose. The authentication utility receives the user credentials and uses the user credentials to authenticate the user. This user credentials may include name and password, face recognition, fingerprint scanning, a security key fob, or any other suitable log in system. The authentication utility 508 also generates an identity assertion token for the user. The identity assertion token includes a personal identifier of the user which is stored in a personal identifiers database 580. The personal identifier is based on information independent of the secured database and independent of the end client that uniquely identifies the user, for example a name, a code, a telephone number, an email address, a data of birth, a social security number, a residential or work address, etc. The information may be modified to protect it from interception using any of a variety of different numerical functions, such as a hash, truncate, inversion, encryption or other function. The personal identifier may alternatively be a number of code that does not contain any personal information.

The identity assertion token may take a variety of different forms. A simple form is simply the personal identifier. A more complex form encapsulates the personal identifier as a packet that contains an encrypted personal identifier with a wrapper. The encapsulated portion may be encrypted to protect the personal identifier and any other information in encapsulated packet. The wrapper may include other information such as an identification of the packet. A more complex form is a web token with a header, an encrypted payload and an authentication utility digital signature. The header, also referred to as a wrapper, contains issuer information, for example an identifier of the authentication utility or the access application, expiration, type of encryptions used, etc. The payload contains at least one personal identifier and may also include other user identifiers, for example a database identification, permissions, roles and other information. The authentication utility digital signature may be included in the header. As mentioned above, a JWT is one example of a suitable format for the identity assertion token.

The access application obtains the user authentication from the authentication utility and also obtains the identity assertion token. The identity assertion token may be stored only in the end client data store 518 or only in the access application user database 522 or both. In some embodiments the personal identifier is known only to the user, the authentication utility, and the secured database. The personal identifier may be encrypted so that the access application cannot determine the personal identifier even if it has the identity assertion token.

In some embodiments the access application also authenticates the user internally by comparing personal identifiers received from an end client to records in the user database 522 that has records for the users and the corresponding credentials. Any of a variety of different authentication techniques and systems may be used. The user database 522 may also contain data to identify the user 502 through the end client 504.

After the user is authenticated and the identity assertion token is received, then the access application sends a database request to the database 510 with the identity assertion token and optionally with a user identifier. In some embodiments the database request includes a unique database identifier that is associated with the permissions and privileges of the user for the database. The database identification may be stored in the end client data store 518 and received from the end client with each database request or it may be retrieved by the access application from the user database 522. The database request is first received by the access application from the end client 504. As used herein, a database request may be for data entry, e.g. writing data into the database, data retrieval, e.g. reading data from the database, or for any other data operation or management tasks.

The database 510 includes an external interface 538 coupled to the access application 506 external interface 528 to communicate requests, replies and other information between the access application and the database. The external interfaces 528, 538 may be connected across an intranet, VPN or the Internet. The database may include secure data 530 and a data engine 532 for performing searches, computations, comparisons, and other operations on the secure data 530 in the database to prepare a reply to the database request.

The database 510 receives the database request that was sent from the end client 504 through the access application 506 with the identity assertion token. The database retrieves the personal identifier from the identity assertion token and compares the received personal identifier with a personal identifier for the user that is stored in a user database 536 of the database 510. When a match is found, then the access application is provided access to the secure data 530 and the database request is performed. The database performs the database request on the secure data 530 of the database 510 and generates a reply in response to the request. The database sends the reply back to the access application. The reply may be an acknowledgment, read data, or a computed result or some other information or combination of information. For a write request, the database may simply acknowledge performance of the requested write. For a read request, the database may send the read data as a reply. For a search or query request, the database may send a search report.

In some embodiments the database also receives a user identifier and applies the user identifier to a record in the user database 536 to retrieve the stored personal identifier. When there is a match, then the database may use the record to obtain a security policy for the user. The user identifier may also be used to ensure that the user identifier and the personal identifier correspond to the same user.

In some embodiments a security policy is enforced at the database by limiting the reply in accordance with the security policy. The database may maintain a security policy in the form of permissions and roles in the user database 536. The security policy may be obtained by applying the received personal identifier to the record of the user in the user database. In some embodiments the access application includes a database identification for the user and the database applies the database identification for the user to determine the security policy. The database determines the permission that are associated with the database identification and the sends the reply from the database to the end client subject to the permissions associated with the database identification.

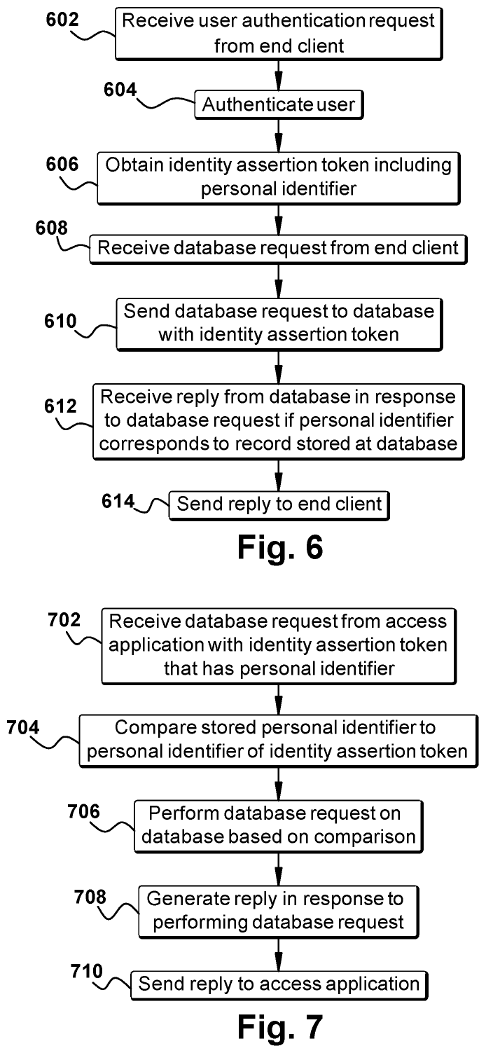

FIG. 6 is a process flow diagram of a method of user security with a middle tier access application. Operation 602 includes receiving a user authentication request from an end client. The user authentication request includes a request to access a database, for example a secured database or a secure data vault. This operation may be performed at an access application that is operating at an end client being used by the user or at another device, for example a server. Operation 604 includes authenticating the user. In some embodiments authenticating the user may be performed as authenticating the user at the access application that is connected through a network to the end client. Authenticating may be done upon receiving user credentials from the end client. In some embodiments authenticating the user includes sending user credentials received from the user through the end client to an external authentication service.

Operation 606 includes obtaining an identity assertion token after authenticating the user. The identity assertion token includes a personal identifier. The identity assertion token may be generated by the access application. In some embodiments obtaining the identity assertion token comprises obtaining the identity assertion token from an external authentication utility. In some embodiments the authentication utility is integrated into the access application. In some embodiments the authentication utility is an external service provided using an external server. The authentication utility can authenticate the user, retrieve a personal identifier from its personal identifier database, and insert the personal identifier into the identity assertion token. The personal identifier may be secured within the identity assertion token using encryption or some other function. In some embodiments the personal identifier is encrypted as a payload of the identity assertion token. The personal identifier may be any secret or unrelated information about the user, such as a telephone number, a security question answer, or arbitrary or coined information.

With external authentication, even if the access application is compromised, the identity assertion token is still secure. When the identity assertion token is signed or even generated by a third-party authentication utility, then the attacker has to breach the third-party authentication utility in order to compromise the identity assertion token.

Having obtained the identity assertion token, the access application may send the identity assertion token to the end client for use by the end client in accessing the database. The end client may then send a database request so that the access application is receiving a database request with the identity assertion token. In some embodiments the access application keeps the identity assertion token and then adds it to any received database request. By not sending the identity assertion token to the end client, the identity assertion token is kept more secure.

Operation 608 includes receiving a database request from the end client. This operation is done also at the access application and may be performed together with the user authentication request. There may be many database requests after the user is authenticated. The user may be operating using an application on an end client, a web interface, or any other suitable user interface.

Operation 610 includes sending the database request to the database with the identity assertion token. The database request may be sent through a secure session that is established between the access application and the database. Operation 612 includes receiving a reply from the database in response to the database request if the personal identifier corresponds to a record stored at the database. If there are permissions associated with the user, then the replay is subject to those permissions. Operation 614 includes sending the reply to the end client.

FIG. 7 is a process flow diagram of a method of user security with a database and an access application. Operation 702 includes receiving a database request at the database from an access application. The database request includes an identity assertion token that has a personal identifier. The database may be connected to the access application through a secure session or an otherwise secure connection. In some embodiments the database request also includes a user identifier.

Operation 704 includes comparing a stored personal identifier associated with the user to the personal identifier of the identity assertion token. When there is a match, then operation 706 includes performing the database request on the database based on the comparing. In some embodiments a user identifier is received with the database request and the database applies the user identifier received from the access application to a record that is stored at the database or at a location accessible to the database and identifies the user. The personal identifier for the identified user is then compared to the personal identifier of the received identity assertion token.

The database may also obtain a security policy of the user by applying the user credentials or a user identifier to the user record at the database. The database request is then performed in accordance with the security policy. The database may also obtain a separate database identifier for the user from the access application. The separate database identifier may include the security policy for the user. In some embodiments the security policy defines permissions and roles that are associated in the user record with the user credentials or with the database identifier.

Operation 708 includes generating a reply in response to performing the database request. The reply may be an acknowledgment, data read from the database, a computed result, or another result. The reply may also be a denial if the personal identifier or the user's database identifier are not consistent with the stored profile of the user. Operation 710 includes sending the reply to the access application. The access application may then receive the reply and send the reply to the end client. The process of database request and database replies may be repeated as suitable for the user interaction with the database.

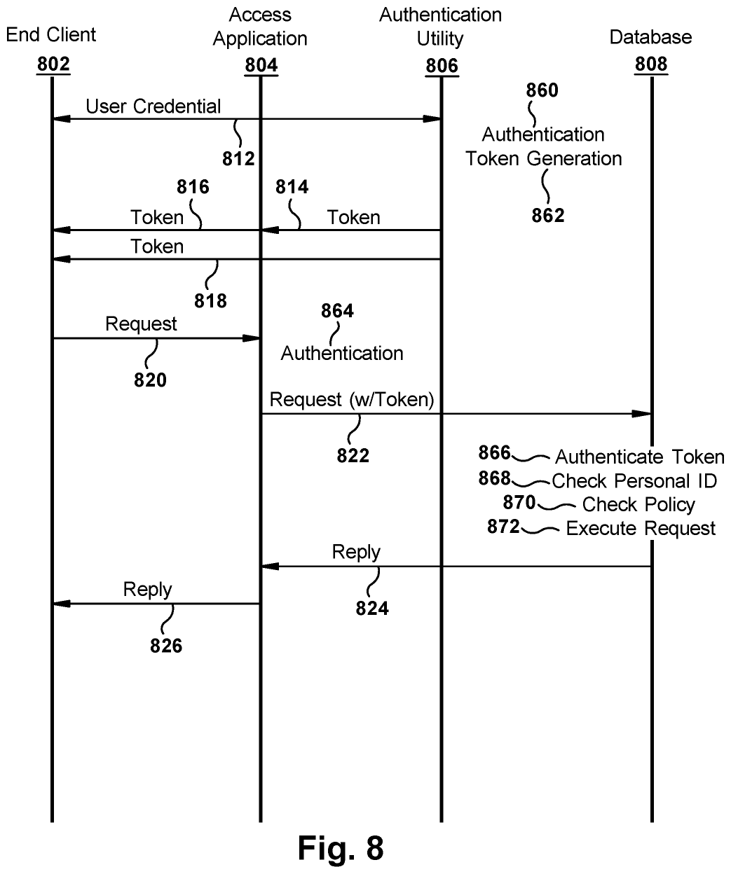

FIG. 8 is a signaling diagram of accessing a database using an identity assertion token. An end client 802 is in direct or indirect communication with an access application 804, an authentication utility 806 and a database 808. The end client 802 authenticates with the authentication utility 806 by sending user credentials with signal 812. The connection between the end client and the authentication utility may be secured through a closed device or network of devices or using a secure connection, for example a VPN, https (Hypertext transfer protocol secure), or any other secure communications format. The authentication utility 806 authenticates the end client at 860. The authentication utility 806 generates an identity assertion token at 862 if the end client is authenticated.

After the authentication, the authentication utility sends an identity assertion token to the access application with signal 814, to the end client with signal 818 or to both the access application and the end client. In some embodiments the access application sends the identity assertion token to the end client with signal 816. As a result, the end client, the access application or both have a stored copy of the identity assertion token for use in accessing the database. The identity assertion token has at least a personal identifier of the user and may have other components including database identification and other information about the user and a digital signature of the authentication utility. In some embodiments the identity assertion token has an expiration so that if an adverse party obtains it, then it cannot be used after it expires. The expiration may be a few seconds, a few minutes, or a few hours, depending on the nature of the components and their connections. The access application may also be connected to the authentication through a closed device or network of devices or using a secure connection, for example a VPN, https (Hypertext transfer protocol secure), or any other secure communications format.

After authentication 860 and obtaining the identity assertion token generated at 862, the end client is able to access the database. The identity assertion token is provided as an example. As explained above, the identity assertion token represents authentication of the user and it contains a secret. As a result, for an adverse party to access the database, the adverse party must have the authentication and the secret. To use the authentication, the adverse party must appear as if it is the access application with its identity and connections. To use the token, the adverse party must actually obtain the token. If the token has an expiration, then the adverse party must obtain the token and use it before it expires.

The end client sends a database request to the access application with signal 820. In this paradigm, the access application has a secure connection with the database and all communications between the end client and the database go through the access application. This allows the access application to maintain an additional level of security. In some implementations, the end client is not secure or the security of the end client is not well controlled. The access application and the authentication utility are well controlled and the security measures are maintained and enforced. By forcing all database interactions through the access application, the access application may compensate for any insecurity at the end client.

The access application receives the database request, authenticates the request at 864 and forwards the request to the database with signal 822. In some embodiments the identity assertion token is attached to the request by the end client and then included in what is forwarded by the access application. In some embodiments the identity assertion token is attached to the request by the access application. The identity assertion token is stored at either the end client, the access application, or both.

When the database request signal 822 is received by the database from the access application, the database is able to ensure that the security of the database is maintained. The database authenticates 866 the token by checking the wrapper or header. As examples of checks that may be performed, the token should have a digital signature of an approved authentication utility. The token should have a source address from an approved access application. The token should not have expired. These and other tests may be performed on the received identity assertion token.

If the identity assertion token is authentic, then the database may parse the token to read the payload and extract the personal identifier. This may include decrypting the personal identifier using a public key that is known to the database and the access application. The personal identifier is then compared to the user data at the database to determine if the request is genuine from the user. Additional operations may be performed 870, for example retrieving permissions, policies, roles and other information using identifications in the request or the token.

The database can then execute 872 the database request subject to any permissions or policies and generate a reply to the request. The reply is then sent to the access application with signal 824 and forwarded from the access application to the end client with signal 826.

In some embodiments the end client may continue to send requests to the database through the access application until the identity assertion token expires. In some embodiments a new token is obtained for each database request.

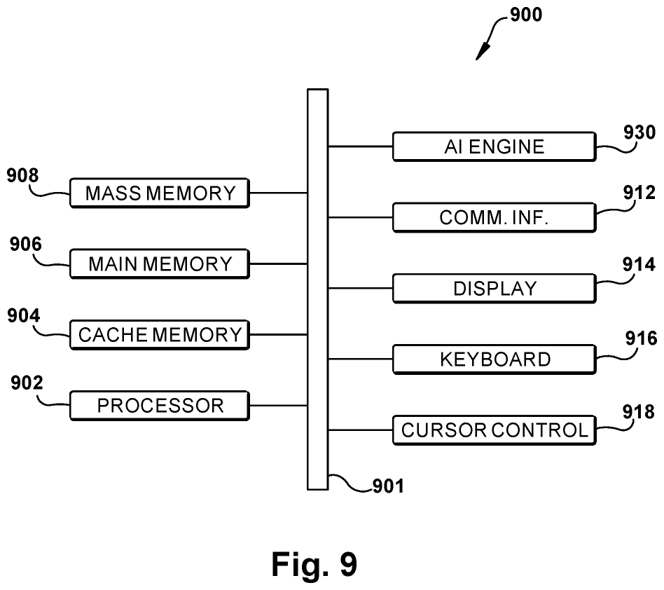

FIG. 9 is a block diagram of a computer system 900 representing an example of a system upon which features of the described embodiments may be implemented, such as the end clients, access applications, authentication utility, governance, workspace, and databases. In the case of cloud services, one or more of the components may be virtualized. The computer system includes a bus or other communication means 901 for communicating information, and a processing means such as one or more microprocessors 902 coupled with the bus for processing information. The computer system further includes a cache memory 904, such as a random access memory (RAM) or other dynamic data storage device, coupled to the bus for storing information and instructions to be executed by the processor. The main memory also may be used for storing temporary variables or other intermediate information during execution of instructions by the processor. The computer system may also include a main nonvolatile memory 906, such as a read only memory (ROM) or other static data storage device coupled to the bus for storing static information and instructions for the processor.

A mass memory 908 such as a solid-state disk, magnetic disk, disk array, or optical disc and its corresponding drive may also be coupled to the bus of the computer system for storing information and instructions. The computer system can also be coupled via the bus to a display device or monitor 914 for displaying information to a user. For example, graphical and textual indications of installation status, operations status, schema configurations, and other information may be presented to the user on the display device. Typically, an alphanumeric input device 916, such as a keyboard with alphanumeric, function and other keys, may be coupled to the bus for communicating information and command selections to the processor. A cursor control input device 918, such as a mouse, a trackball, trackpad, or cursor direction keys can be coupled to the bus for communicating direction information and command selections to the processor and to control cursor movement on the display.

A communication device 912 is also coupled to the bus. The communication device may include a wired or wireless modem, a network interface card, or other well-known interface devices, such as those used for coupling to Ethernet, token ring, cellular telephony, Wi-Fi, or other types of physical attachment for purposes of providing a communication link to support a local or wide area network (LAN or WAN), for example. In this manner, the computer system may also be coupled to a number of clients or servers via one or more conventional network infrastructures, including an Intranet or the Internet, for example.

The system of FIG. 9 further includes an AI (Artificial Intelligence) engine. This may be implemented in dedicated hardware using parallel processing or in the processor 902 or using some combination of resources. The AI engine may also be external to the computer system 900 and connected through a network node or some other means. The AI engine may be configured to use historical data accumulated by the computer system or another system to build a model that includes weights and criteria to apply to the selection processes, operations, and encryption among others. The model may be repeatedly rebuilt using the accumulated data to refine and increase accuracy.

A lesser or more equipped computer system than the example described above may be preferred for certain implementations. Therefore, the configuration of the exemplary computer system will vary from implementation to implementation depending upon numerous factors, such as price constraints, performance requirements, technological improvements, or other circumstances. The computer system may be duplicated in different locations for distributed computing. As an example, the system may use a simple pre-programmed deterministic selection model instead of an AI model and the AI engine.

While the steps described herein may be performed under the control of a programmed processor, in alternative embodiments, the steps may be fully or partially implemented by any programmable or hard coded logic, such as Field Programmable Gate Arrays (FPGAs), Transistor-Transistor Logic (TTL), or Application Specific Integrated Circuits (ASICs), for example. Additionally, the methods described herein may be performed by any combination of programmed general purpose computer components or custom hardware components. Therefore, nothing disclosed herein should be construed as limiting the present invention to a particular embodiment wherein the recited steps are performed by a specific combination of hardware components.

In the present description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. The specific detail may be supplied by one of average skill in the art as appropriate for any particular implementation.

The present description includes various steps, which may be performed by hardware components or may be embodied in machine-readable instructions, such as software or firmware instructions that are stored on a machine-readable medium, such as a memory or storage device. The machine-readable instructions may be used to cause a general-purpose or special-purpose processor programmed with the instructions to perform the steps. Alternatively, the steps may be performed by a combination of hardware and software.

The described operations may be provided as a computer program product that may include a machine-readable medium having stored instructions thereon, which may be used to program a computer (or other machine) to perform a process according to the present invention. The machine-readable medium may include, but is not limited to optical disks, CD-ROMs, and magneto-optical disks, ROMs, RAMs, EPROMs, EEPROMs, magnet or optical cards, flash memory, or any other type of medium suitable for storing electronic instructions. Moreover, the present invention may also be downloaded as a computer program product, wherein the program may be transferred from a remote computer to a requesting computer by way of data signals embodied in a carrier wave or other machine-readable propagation medium via a communication link (e.g., a modem or network connection).

Some embodiments described herein pertain to a non-transitory machine-readable medium comprising a plurality of instructions, executed on a computing device, to facilitate the computing device to perform one or more of any of the operations described in the various embodiments herein.

Although this disclosure describes some embodiments in detail, it is to be understood that the invention is not limited to the precise embodiments described. The specification and drawings are, accordingly, to be regarded in an illustrative rather than a restrictive sense. Various adaptations, modifications and alterations may be practiced within the scope of the invention defined by the appended claims.

Aspects disclosed herein include a method of receiving a user authentication request from an end client, the user authentication request being a request to access a database, authenticating the user, obtaining an identity assertion token after authenticating the user, the identity assertion token including a personal identifier, receiving a database request from the end client, sending the database request to the database with the identity assertion token, receiving a reply from the database in response to the database request if the personal identifier corresponds to a record stored at the database, and sending the reply to the end client.

In some embodiments authenticating the user comprises authenticating the user at an access application that is connected through a network to the end client. In some embodiments authenticating the user comprises sending user credentials to an external authentication service. In some embodiments. In some embodiments obtaining the identity assertion token comprises obtaining the identity assertion token from the external authentication utility. In some embodiments the personal identifier is retrieved from a database of the authentication utility and inserted into the identity assertion token by the authentication utility.

Some embodiments include sending the identity assertion token to the end client and wherein receiving a database request comprises receiving the identity assertion token. In some embodiments sending the database request comprises sending the database request through a secure session with the database. In some embodiments the reply comprises data from a search report in the database request. In some embodiments sending the database request comprises sending a database identification to the database and wherein receiving a reply from the database comprises receiving a reply subject to permissions associated with the database identification.

Aspects disclosed herein include an access application with an end client interface to receive a user authentication request from an end client, the user authentication request being a request to access a database and to receive a database request from the end client, an authentication utility to authenticate the user and provide an identity assertion token after authenticating the user, the identity assertion token including a personal identifier, and an external interface to send the database request to the database with the identity assertion token and to receive a reply from the database in response to the database request if the personal identifier corresponds to a record stored at the database, wherein the end client interface sends the reply to the end client.

Some embodiments include a users database to store the identity assertion token in association with the user. In some embodiments the end client interface is further to send the identity assertion token to the end client and to receive the database request with the identity assertion token. Some embodiments include a session engine to establish a secure session with the database.

Aspects disclosed herein include a method of receiving a database request from an access application, the database request including an identity assertion token that has a personal identifier, the personal identifier identifying a user, comparing a stored personal identifier associated with the user to the personal identifier of the identity assertion token, performing the database request on the database based on the comparing, generating a reply in response to performing the database request, and sending the reply to the access application.

In some embodiments receiving a database request comprises receiving the database request from an access application through a secure session with the access application. In some embodiments receiving the database request comprises receiving a database identification of the user, the method further comprising applying the database identification to a record of the database and wherein comparing a stored personal identifier comprises comparing a stored personal identifier associated with the record.

Some embodiments include obtaining a security policy of the user by applying the database identification to the record and wherein performing the database request comprises performing the database request in accordance with the security policy. In some embodiments the security policy defines permissions and roles that are associated in the record with the user. In some embodiments the reply comprises at least one of an acknowledgment, read data, and a computed result. In some embodiments the personal identifier comprises a number associated with the user independent of an end client associated with the user.

Aspects disclosed herein include a database with secure data, an external interface to receive a database request from an access application, the database request including an identity assertion token that has a personal identifier, the personal identifier identifying a user, a users database containing stored personal identifiers associated with users, and a data engine to compare the personal identifier of the identity assertion token to store personal identifiers, to perform the database request on the secure data based on the comparing, and to generate a reply in response to performing the database request, wherein the external interface is further to send the reply to the access application.

In some embodiments the database request includes a database identification of the user, wherein the data engine applies the database identification to a record of the users database and wherein comparing a stored personal identifier comprises comparing a stored personal identifier associated with the record. In some embodiments the users database further contains a security policy of the user and wherein the data engine performs the database request in accordance with the security policy.

What is claimed is:

1. A method comprising
receiving a user authentication request from an end client, the user authentication request being a request to access a database;
authenticating the user;
obtaining an identity assertion token after authenticating the user, the identity assertion token including a personal identifier;
receiving a database request from the end client;
sending the database request to the database with the identity assertion token;
receiving a reply from the database in response to the database request if the personal identifier corresponds to a record stored at the database; and
sending the reply to the end client.

2. The method of claim 1, wherein authenticating the user comprises authenticating the user at an access application that is connected through a network to the end client.

3. The method of claim 1, wherein authenticating the user comprises sending user credentials to an external authentication service.

4. The method of claim 3, wherein obtaining the identity assertion token comprises obtaining the identity assertion token from the external authentication utility.

5. The method of claim 4, wherein the personal identifier is retrieved from a database of the authentication utility and inserted into the identity assertion token by the authentication utility.

6. The method of claim 1, further comprising sending the identity assertion token to the end client and wherein receiving a database request comprises receiving the identity assertion token.

7. The method of claim 1, wherein sending the database request comprises sending the database request through a secure session with the database.

8. The method of claim 1, wherein the reply comprises data from a search report in the database request.

9. The method of claim 1, wherein sending the database request comprises sending a database identification to the database and wherein receiving a reply from the database comprises receiving a reply subject to permissions associated with the database identification.

10. An access application comprising
an end client interface to receive a user authentication request from an end client, the user authentication request being a request to access a database and to receive a database request from the end client;
an authentication utility to authenticate the user and provide an identity assertion token after authenticating the user, the identity assertion token including a personal identifier; and
an external interface to send the database request to the database with the identity assertion token and to receive a reply from the database in response to the database request if the personal identifier corresponds to a record stored at the database;
wherein the end client interface sends the reply to the end client.

11. The access application of claim 10, further comprising a users database to store the identity assertion token in association with the user.

12. The access application of claim 10, wherein the end client interface is further to send the identity assertion token to the end client and to receive the database request with the identity assertion token.

13. The access application of claim 10, further comprising a session engine to establish a secure session with the database.

14. A method comprising:
receiving a database request from an access application, the database request including an identity assertion token that has a personal identifier, the personal identifier identifying a user;
comparing a stored personal identifier associated with the user to the personal identifier of the identity assertion token;
performing the database request on the database based on the comparing;
generating a reply in response to performing the database request; and
sending the reply to the access application.

15. The method of claim 14, wherein receiving a database request comprises receiving the database request from an access application through a secure session with the access application.

16. The method of claim 14, wherein receiving the database request comprises receiving a database identification of the user, the method further comprising applying the database identification to a record of the database and wherein comparing a stored personal identifier comprises comparing a stored personal identifier associated with the record.

17. The method of claim 16, further comprising obtaining a security policy of the user by applying the database identification to the record and wherein performing the database request comprises performing the database request in accordance with the security policy.

18. The method of claim 17, wherein the security policy defines permissions and roles that are associated in the record with the user.

19. The method of claim 14, wherein the reply comprises at least one of an acknowledgment, read data, and a computed result.

20. The method of claim 14, wherein the personal identifier comprises a number associated with the user independent of an end client associated with the user.

21. A database comprising:
secure data;
an external interface to receive a database request from an access application, the database request including an identity assertion token that has a personal identifier, the personal identifier identifying a user;
a users database containing stored personal identifiers associated with users; and
a data engine to compare the personal identifier of the identity assertion token to store personal identifiers, to perform the database request on the secure data based on the comparing, and to generate a reply in response to performing the database request,
wherein the external interface is further to send the reply to the access application.

22. The database of claim 21, wherein the database request includes a database identification of the user, wherein the data engine applies the database identification to a record of the users database and wherein comparing a stored personal identifier comprises comparing a stored personal identifier associated with the record.

23. The database of claim 21, wherein the users database further contains a security policy of the user and wherein the data engine performs the database request in accordance with the security policy.
